(19) United States
(12) Patent Application Publication
(10) Pub. No.: US 2016/0364696 A1
(43) Pub. Date: Dec. 15, 2016

(54) MEETING SCHEDULER FOR AUTOMATED FACE-TO-FACE MEETING GENERATION

(71) Applicant: INTERNATIONAL BUSINESS MACHINES CORPORATION, Armonk, NY (US)

(72) Inventors: Swaminathan BALASUBRAMANIAN, Southfield, MI (US); Ravi P. BANSAL, Tampa, FL (US); Nilesh H. BANTE, Pune (IN); Sandip D. MAHAJAN, Nagpur (IN)

(21) Appl. No.: 14/734,627

(22) Filed: Jun. 9, 2015

(51) Int. Cl. G06Q 10/10

(52) U.S. Cl. CPC G06Q 10/1095

(57) ABSTRACT

Approaches are provided for rescheduling a meeting as a face-to-face meeting. An approach includes collecting location information from each attendee of a scheduled meeting. The approach further includes determining whether a minimum number of attendees to the scheduled meeting will be co-located at a comparable time. The approach further includes determining whether the comparable time is within an advancement or postponement window of time when the minimum number of attendees will be co-located at the comparable time. The approach further includes sending a notification to a host of the scheduled meeting that there is an opportunity to reschedule the scheduled meeting as a face-to-face meeting at the comparable time when the comparable time is within the advancement or postponement window of time. The approach further includes receiving a request to reschedule the meeting and rescheduling the scheduled meeting as a face-to-face meeting.

### FIELD OF THE INVENTION

The present invention generally relates to electronic data management, and more particularly, to a method and system for managing an electronic scheduling or calendaring application using real time information to automatically schedule a face-to-face meeting.

### BACKGROUND

Electronic scheduling or calendaring applications have transformed personal and business time management. In particular, scheduling or calendaring applications have become a standard feature on many computing devices, such as personal computers, personal digital assistants (PDAs), enterprise digital assistants (EDAs), and smartphones (e.g., a mobile phone with a mobile computing platform). The scheduling or calendaring applications employed on many of these devices generally provide users with an electronic version of the traditional paper calendar and may enable a user to synchronize with an online storage of calendar events such that all of a user's devices are updated with the same information, e.g., schedule of events. These devices have evolved over time and eased the process of recording and providing the ability to share events.

The conventional scheduling or calendaring applications characteristically permit users to make schedule entries that are based on time, allow for user's to monitor the scheduled entries, and take action against various occurring events (e.g., a timing conflict between attendees). In contrast, more and more activities are based on or associated with places or events rather than simply time, which require a more robust system of monitoring to ensure that action is taken against various occurring events. Although there are some scheduling or calendaring applications that utilize “extrinsic” events like weather to control a scheduled meeting, the conventional scheduling or calendaring applications do not provide the user with the ability to intelligently monitor “intrinsic” events such as “locations of the attendees”, “travel schedules of attendees”, “instant message chat sessions of attendees”, and the like, and automatically reschedule a meeting's time and location based on the various “intrinsic” events.

### SUMMARY

In a first aspect of the invention, a method is implemented in a computer infrastructure having computer executable code tangibly embodied on a computer readable storage medium having programming instructions operable to: collect location information from each attendee of a scheduled meeting; determine whether a minimum number of the attendees of the scheduled meeting will be co-located at a comparable time; when the minimum number of the attendees will be co-located at the comparable time, determine whether the comparable time is within an advancement or postponement window of time; when the comparable time is within the advancement or postponement window of time, send a notification to a host of the scheduled meeting that there is an opportunity to reschedule the scheduled meeting as a face-to-face meeting at the comparable time; receive a request to reschedule the scheduled meeting as the face-to-face meeting; and reschedule the scheduled meeting as the face-to-face meeting.

In another aspect of the invention, computer program product is provided for rescheduling a scheduled meeting as a face-to-face meeting on a computing device. The computer program product comprises a computer readable storage medium having program instructions embodied therewith, where the computer readable storage medium is not a transitory signal per se, and the program instructions are readable by a computing device to cause the computing device to perform a method comprising: obtaining information pertaining to the scheduled meeting, the information including a list of attendees of the meeting and a mobile device for each attendee; collecting location information from the mobile device of each attendee of the scheduled meeting; determining whether a minimum number of the attendees of the scheduled meeting will be co-located at a comparable time based on the location information; when the minimum number of the attendees will be co-located at the comparable time, determining whether the comparable time is within an advancement or postponement window of time; when the comparable time is within the advancement or postponement window of time, sending a notification to a host of the scheduled meeting that there is an opportunity to reschedule the scheduled meeting as the face-to-face meeting at the comparable time; receiving a request to reschedule the scheduled meeting as the face-to-face meeting; and rescheduling the scheduled meeting as the face-to-face meeting.

In yet another aspect of the invention, a system comprises a CPU, a computer readable memory and a computer readable storage medium. The system further comprises: program instructions to receive user preferences for a layout or format of content displayed on a computing device; program instructions to obtain information pertaining to a scheduled telephone or web conference meeting, the information including a list of attendees of the meeting and a mobile device for each attendee; program instructions to collect location information from the mobile device of each attendee of the scheduled telephone or web conference meeting; program instructions to collect travel itinerary information stored in a company travel database for each attendee of the scheduled telephone or web conference meeting; program instructions to determine whether a minimum number of the attendees of the scheduled telephone or web conference meeting will be co-located at a comparable time based on the location information and travel itinerary information; program instructions to when the minimum number of the attendees will be co-located at the comparable time, determine whether the comparable time is within an advancement or postponement window of time; program instructions to when the comparable time is within the advancement or postponement window of time, send a notification to a host of the scheduled telephone or web conference meeting that there is an opportunity to reschedule the scheduled telephone or web conference meeting as the face-to-face meeting at the comparable time; program instructions to receive a request to reschedule the scheduled telephone or web conference meeting as the face-to-face meeting; and program instructions to reschedule the scheduled telephone or web conference meeting as the face-to-face meeting. The program instructions are stored on the computer readable storage medium for execution by the CPU via the computer readable memory.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with aspects of the invention.

FIG. 2 shows a high level architecture for implementing processes in accordance with aspects of the invention.

FIGS. 3 and 4 show exemplary flows in accordance with aspects of the invention.

FIGS. 5 and 6 show visual representations of examples of operation in accordance with aspects of the invention.

### DETAILED DESCRIPTION

The present invention generally relates to electronic data management, and more particularly, to a method and system for managing an electronic scheduling or calendaring application using real time information to automatically schedule a face-to-face meeting. More specifically, implementations of the invention provide systems and methods to maximize the likelihood that a meeting is scheduled to occur face-to-face. In embodiments, when scheduling a meeting, a host configures a set of conditions such as a minimum number of possible co-located attendees, a reschedule window, attendee travel itineraries, geographical locations of attendees, groupings of attendees, etc., that may be used by the present invention to maximize the likelihood that the meeting is scheduled to occur face-to-face. Once the meeting is scheduled, the systems and methods may monitor one or more systems associated with each attendee (e.g., a calendar or global positioning coordinates for each attendee). When one or more of the set of conditions is met, the systems and methods of the present invention may be configured to propose a reschedule of the meeting to a face-to-face meeting. Advantageously, the systems and methods of the present invention capture and utilize real time information to suggest alternate meeting times that will allow the host and attendees to have face-to-face conversations in a same physical location rather than a telephone or web conference with attendees in different physical locations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

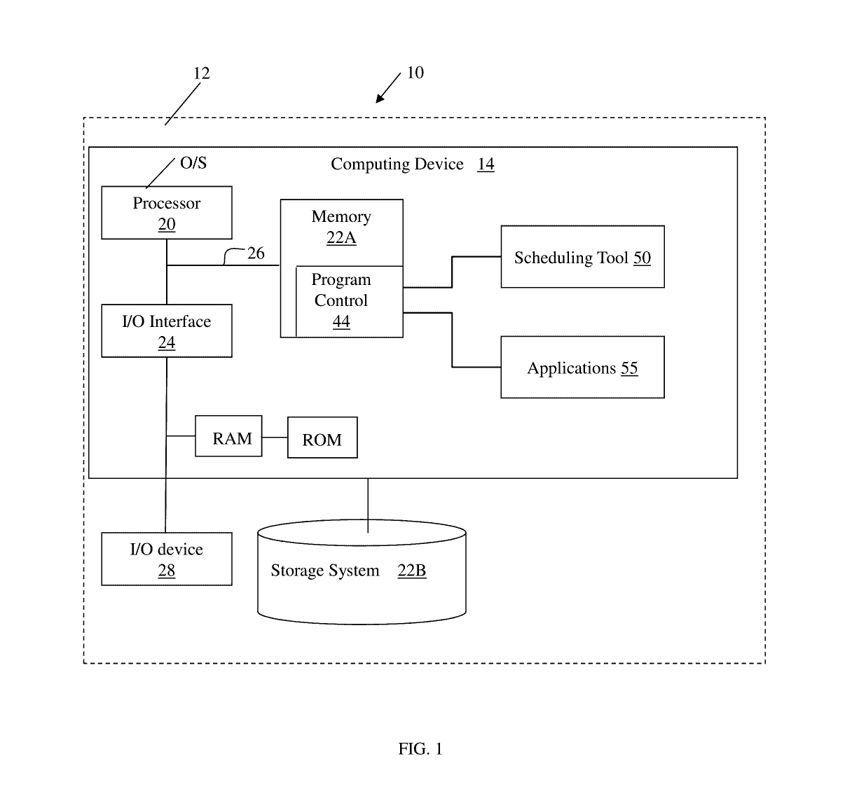

FIG. 1 shows an illustrative environment 10 for managing the processes in accordance with the invention. To this extent, environment 10 includes a server 12 or other computing system that can perform the processes described herein. In particular, server 12 includes a computing device 14. The computing device 14 can be resident on a network infrastructure or computing device of a third party service provider (any of which is generally represented in FIG. 1).

The computing device 14 also includes a processor 20 (e.g., CPU), memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 (e.g., graphic user interface) or any device that enables computing device 14 to communicate with one or more other computing devices using any type of communications link. The external I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a scheduling tool 50 and scheduling or calendaring applications 55, which perform processes described herein. The scheduling tool 50 and scheduling or calendaring applications 55 can be implemented as one or more program code in program control 44 stored in memory 22A as separate or combined modules. Additionally, the scheduling tool 50 and scheduling or calendaring applications 55 may be implemented as separate dedicated processors or a single or several processors to provide the function of the scheduling tool 50 and scheduling or calendaring applications 55. While executing the computer program code, the processor 20 can read and/or write data to/from memory 22A, storage system 22B, and/or I/O interface 24. The program code executes the processes of the invention. The bus 26 provides a communications link between each of the components in computing device 14.

In embodiments, the scheduling tool 50 may be implemented within the O/S of the computing device 14 (e.g., a personal computer or mobile device), within the scheduling or calendaring applications 55, or as a standalone application or module within the computing device 14, and made available (e.g., made available as a service) to the scheduling or calendaring applications 55 of the computing device 14 by way of an application programming interface (API) framework. The API framework defines a set of functionalities of the scheduling tool 50 that are independent of their respective implementation, allowing both definition and implementation to vary without compromising each other. The API framework is used to allow for the integration of new functionality (e.g., intelligent event monitoring and automated rescheduling of events) into the scheduling or calendaring applications 55 of the computing device 14, or to share data between the scheduling or calendaring applications 55 and the scheduling tool 50.

By way of example, the scheduling tool 50 may be configured to provide functionality alone or via the API framework for rescheduling a scheduled meeting to a face-to-face meeting. In embodiments, upon obtaining location information pertaining to attendees of a scheduled meeting, the scheduling tool 50 may be further configured to determine whether a minimum number of attendees to the scheduled meeting will be co-located at a comparable time, determine whether the comparable time is within an advancement or postponement window of time when the minimum number of attendees will be co-located at the comparable time, send a notification to a host of the scheduled meeting that there is an opportunity to reschedule the scheduled meeting as a face-to-face meeting at the comparable time when the comparable time is within the advancement or postponement window of time, receive a request to reschedule the meeting, and rescheduling the scheduled meeting as a face-to-face meeting.

The computing device 14 can comprise any general purpose computing article of manufacture capable of executing computer program code installed thereon (e.g., a personal computer, a mobile device, a server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, server 12 is only illustrative of various types of computer infrastructures for implementing the invention. For example, in embodiments, server 12 comprises two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

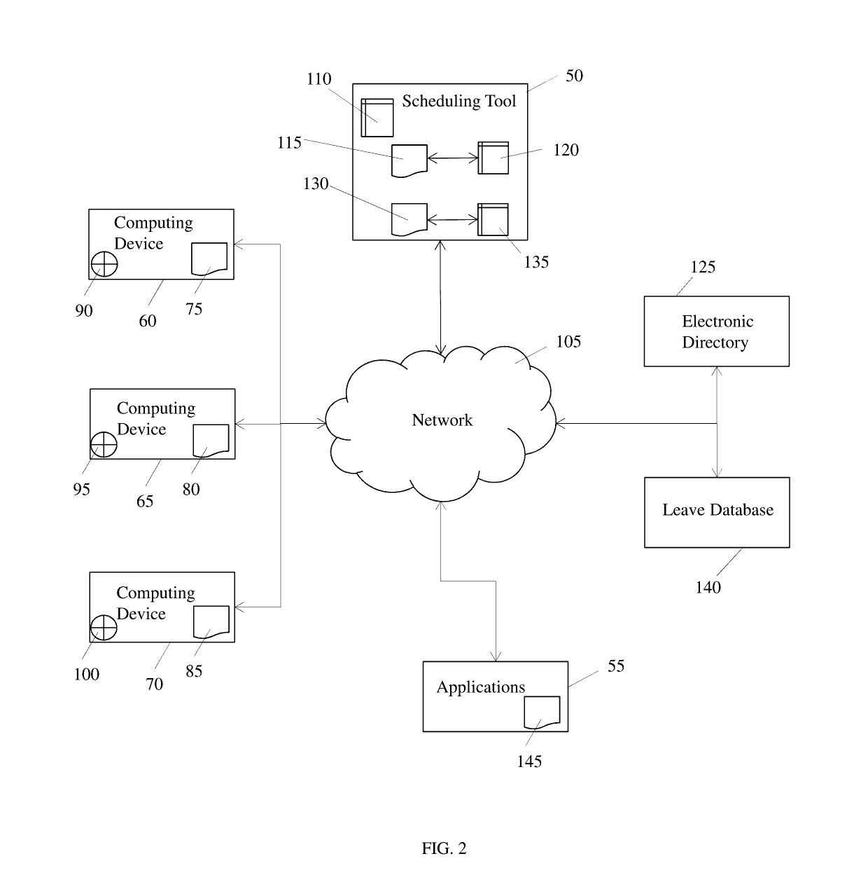

FIG. 2 illustrates a scheduling tool 50 (e.g., scheduling tool 50 as described with respect to FIG. 1) and computing devices 60, 65, and 70 owned by potential invitees to a meeting, according to one embodiment of the present invention. In embodiments, each of the computing devices 60, 65, and 70 may include one or more applications 75, 80, and 85 (e.g., a scheduling or calendaring application) that are accessible by the scheduling tool 50. Additionally, in embodiments, each of the computing devices 60, 65, and 70 may be a mobile computing device and may include a respective global positioning system (GPS) unit 90, 95, and 100, which communicates with satellites, not shown, to determine their geographic positions. The computing devices 60, 65, and 70 may have tracking capabilities, such as being equipped with different means to track its location, for example, cell phones may be tracked through signals sent and received by an operator (e.g., triangulation methods). Once determined, the computing devices 60, 65, and 70 can communicate their geographic positions to scheduling tool 50 via available communications network 105, such as a local area network, a wide area network, or a wireless device service provider (e.g., a cell phone service provider).

Alternatively, the tracking device may be separate from the computing device but can communicate with the computing devices 60, 65, and 70 either directly (peer to peer) or indirectly (via an intermediary such as a central server). For example, a building access card issued by a company can also be used to schedule a meeting. For example, if meeting invitees (such as the employees of a company) use a company ID card with a magnetic strip to swipe themselves into the company premises, that information tracked by the card terminals can be accessed by the scheduling application of the present invention, assuming it has been authorized to do so. The scheduling tool 50 can then use this to determine the location of attendees and reschedule their telephonic meeting into a face-to-face meeting if they happen to be co-located in the same building or a building close to one another (because they swiped their card at the same building).

As described in more detail below, scheduling tool 50 maintains a database or hash table 110 of a multitude of wireless devices such as the computing devices 60, 65, and 70, which are owned by potential invitees to meetings. These devices may have been previously registered with scheduling tool 50 by the host of the meeting or could have been registered by the employer of the host, if any. The database 110 may be propagated with the host's own address book within an application such as the scheduling or calendaring applications 55 (e.g., as described with respect to FIG. 1). The database 110 lists the identity of each device such as the computing devices 60, 65, and 70, the registered owner of each device, and the current location of each device, if known. The current location is determined by the respective GPS device such as GPS unit 90, 95, and 100 of the computing devices 60, 65, and 70 and relayed by the devices to scheduling tool 50. Scheduling tool 50 further includes a scheduler program 115, which maintains a meeting schedule table 120 that lists proposed and scheduled meetings between owners of the computing devices 60, 65, and 70, the list of invitees for each meeting, the purpose of each meeting, the meeting location, and links to previous correspondence between the invitees on the subject of the meeting. Scheduling tool 50 has access to an electronic directory 125 with the telephone numbers and nominal addresses of the owners of the computing devices 60, 65, and 70, the IP addresses of the wireless devices of the owners, and company ID card information, e.g., building access cards.

Scheduling tool 50 also includes a parameters and preferences program 130, which maintains a parameters and preferences table 135 that lists a number of predefined parameters or preferences, for example, a defined minimum number of attendees that must be co-located to reschedule a meeting as a face-to-face meeting, minimum number of days prior to the scheduled meeting that must be available to reschedule the meeting, a maximum number of days in the future that are available and cannot be surpassed to reschedule the meeting, authorization to track attendees travel schedule or itinerary to reschedule a meeting as a face-to-face meeting, authorization to find resources for holding a face-to-face meeting, and a minimum number of user co-located that satisfy a grouping of attendees to reschedule a meeting as a face-to-face meeting on a group level. Scheduling tool 50 additionally has access to a vacation planner and/or leave database 140 with the travel schedules of attendees.

As explained in more detail below, when a user of the scheduling or calendaring applications 55 initiates a meeting request for specified invitees, the scheduling or calendaring applications 55 sends out invitations for the invitees, blocks off the time for the meeting on an electronic calendar, and tracks all invitees that have accepted the meeting invitation. In embodiments, the scheduling or calendaring applications 55 may include a scheduling assistant 145 for automated assistance in finding a best time for the meeting such that all or most invitees can attend the meeting. In accordance with aspects of the preset invention, the scheduling or calendaring applications 55 includes access to the scheduling tool 50 to help reschedule the meeting if the meeting can occur face-to-face rather than remotely (e.g., via a telephone or web conference).

As explained in more detail below, in instances in which the assistance of the scheduling tool 50 is elected and once the meeting is scheduled, the scheduling tool 50 begins monitoring and generating attendee information based on preferences provided in the preference table 135. If the host selects a minimum number of possible co-located attendees, the scheduling tool 50 will track the attendees' locations using various techniques such as their IP address (e.g., obtained from electronic directory 125 and saved in database 110), GPS (e.g., obtained from GPS unit 90, 95, and 100 and saved in database 110), company ID card databases (e.g., obtained from electronic directory 125 and saved in database 110), etc., to identify whether the number of attendees located at any location is greater than or equal to the minimum number set by the host.

As to the use of an “IP address” in the context of using it as a means to find a meeting attendee's location, the meeting invitees may be logging into the company network from various locations using their laptops or other devices. The IP addresses they are using to log into the corporate network can be used to determine their location (Geo IP location). The scheduling tool 50 could then reschedule their telephonic meeting into a face-to-face meeting if they happen to be co-located (because the IP Addresses indicate they are in the same location).

If the host selects authorization to review attendees' travel schedules, the scheduling tool 50 will capture the attendees' travel plans using various techniques such as a vacation planner and/or leave database 145, online travel reservations, etc. to identify whether the attendees are travelling to a same geographic location. If the host selects attendees' location, the scheduling tool 50 will track whether multiple attendees are present at a same location (e.g., city, town, office building, shopping mall, coffee shop, etc.) by using GPS and other equivalent technologies. When one or more of conditions provided within the preferences is satisfied by the monitored and generated attendee information, the scheduling tool 50 will suggest one or more alternative times to reschedule the meeting such that the meeting can be held as a face-to-face meeting rather than a telephone or web conference meeting.

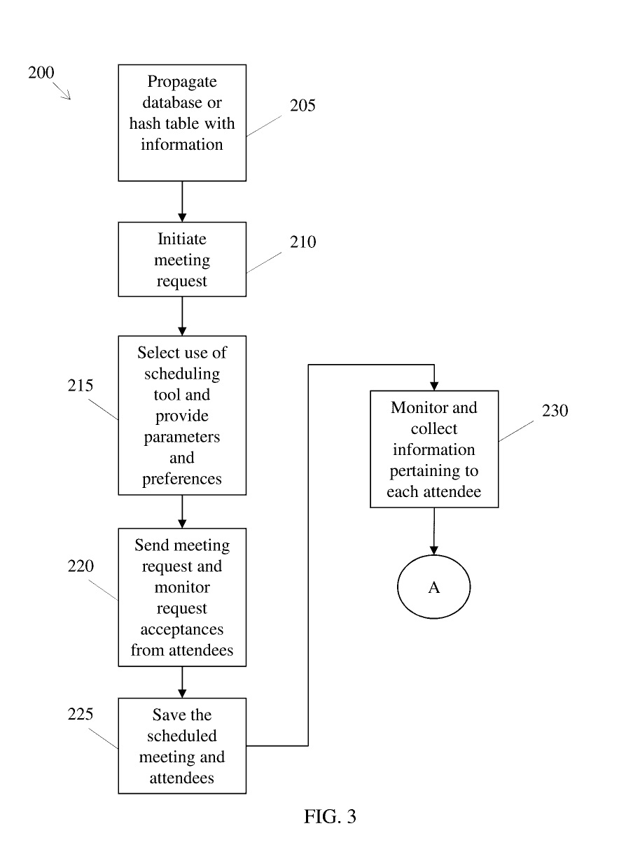

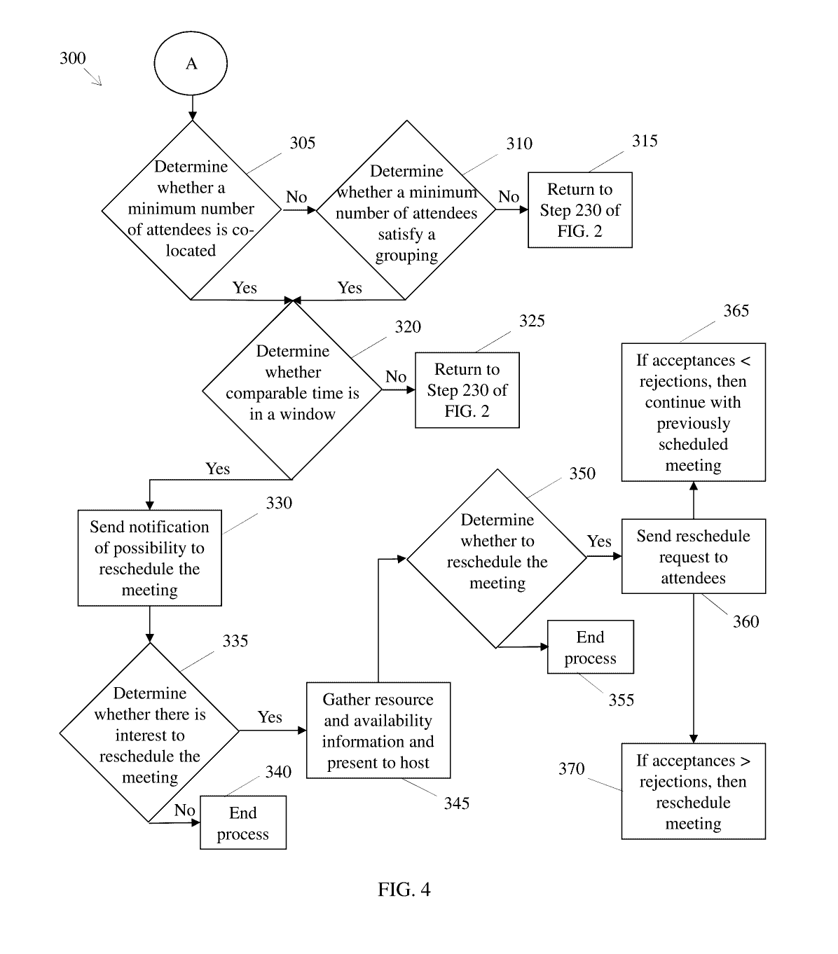

FIGS. 3 and 4 show exemplary flows for performing aspects of the present invention. The steps of FIGS. 3 and 4 may be implemented in the environment of FIG. 1, for example. As noted above, the flowchart(s) illustrate the architecture, functionality, and operation of possible implementations of systems, methods, and computer program products as already described herein in accordance with the various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 3 is a flow diagram illustrating a process 200 for monitoring and generating information about attendees of a meeting. At step 205, a database or hash table is propagated with information regarding a host of a meeting and one or more potential invitees to the meeting. For example, a scheduling tool (e.g., scheduling tool 50 described with respect to FIGS. 1 and 2) may be configured to propagate a database or hash table (e.g., database or hash table 110 described with respect to FIG. 2) with information (e.g., contacts of the host and any information pertaining to each contact such as personal address, office address, phone number, cell phone number, etc.) from the host's own address book within an application such as the scheduling or calendaring applications 55 (e.g., as described with respect to FIGS. 1 and 2). In embodiments, the computing devices (e.g., the computing devices 60, 65, and 70 as described with respect to FIG. 2) of each of the contacts (i.e., potential invitees to a meeting) may have been previously registered with the scheduling tool 50 by the host, by the one or more contacts, or could have been registered by the employer of the host or one or more contacts, if any. Consequently, the database or hash table lists the one or more contacts of the host as a registered owner of each computing device, the identity of each computing device, and any contact information that is available from the host's own address book such as address information for each contact.

In additional or alternative embodiments, the scheduling tool 50 may also be configured to propagate the database or hash table with information from an external electronic directory (e.g., electronic directory 125 as described with respect to FIG. 2). The electronic directory may include telephone numbers and addresses of the one or more contacts of the host, the computing devices of the one or more contacts, the IP addresses of the computing devices of the one or more contacts, employee ID card information, preferences of the one or more contacts (e.g., authorization to access one or more applications on the computing devices of the contacts), etc. Consequently, the database or hash table lists the one or more contacts of the host as a registered owner of each computing device, the identity of each computing device, any contact information that is available for each contact, the IP address of each computing device, preferences of each contact, and employee ID card information of each contact.

At step 210, a user of a scheduling or calendaring application initiates a meeting request for specified invitees. For example, the user may utilize the scheduling or calendaring application (e.g., scheduling or calendaring applications 55 as discussed with respect to FIGS. 1 and 2) to select a new meeting request, insert a subject pertaining to the meeting, insert a location of the meeting (e.g., a room for a face-to-face meeting, web cast information for a web cast meeting, a telephone number for a telephonic meeting, etc.), insert a start time and end time for the meeting, attach an information pertaining to the meeting such as power point documents, optionally select use of a scheduling assistant (e.g., scheduling assistant 145 as discussed with respect to FIG. 2) to help find a best time for the meeting, and add invitees to the meeting (e.g., required, optional, and resource invitees).

At step 215, the user of the scheduling or calendaring application optionally selects use of the scheduling tool to help reschedule the meeting if the meeting can occur face-to-face rather than remotely (e.g., via a telephone or web conference). For example, the user may utilize the scheduling or calendaring application (e.g., scheduling or calendaring applications 55 as discussed with respect to FIGS. 1 and 2) to select use of the scheduling tool (e.g., scheduling tool 50 as described with respect to FIGS. 1 and 2) to help reschedule the meeting. Once use of the scheduling tool is elected, the scheduling tool is configured to communicate with the scheduling or calendaring application to obtain one or more preferences or parameters (e.g., using parameters and preferences program 130, which maintains a parameters and preferences table 135 as described with respect to FIG. 2) from the user for the meeting that define conditions upon which the scheduling tool may reschedule the meeting if the meeting can occur face-to-face.

In embodiments, the one or more parameters or preferences may include: (i) a defined minimum number of attendees that must be co-located to reschedule a meeting as a face-to-face meeting, (ii) a minimum number of days prior to the scheduled meeting that must be available to reschedule the meeting, (iii) a maximum number of days in the future that are available and cannot be surpassed to reschedule the meeting, (iv) authorization to track attendees travel schedule or itinerary to reschedule a meeting as a face-to-face meeting, (v) authorization to find resources for holding a face-to-face meeting, and (vi) a minimum number of user co-located that satisfy a grouping of attendees to reschedule a meeting as a face-to-face meeting on a group level.

At step 220, once the user has set up the one or more parameters and preferences for the scheduling tool, the meeting request is sent to the specified invitees, time for the meeting is blocked off on an electronic calendar of the host, and acceptances of the meeting request by the specified invitees are tracked. For example, the user may utilize the scheduling or calendaring application (e.g., scheduling or calendaring applications 55 as discussed with respect to FIGS. 1 and 2) to send the meeting request to the specified invitees, and thereafter the scheduling or calendaring application may be configured to automatically block off time for meeting on the host's electronic calendar and track acceptances of the meeting request from the specified invitees. In embodiments, the scheduling or calendaring application may be further configured to designate the host and specified invitees that have accepted the meeting request as attendees of the meeting.

At step 225, the scheduled meeting is saved in a database with attendees of the meeting. For example, the scheduling tool (e.g., scheduling tool 50 as discussed with respect to FIGS. 1 and 2) maintains a table (e.g., schedule table 120 via scheduler program 115) with all proposed and scheduled meetings that the schedule tool has been elected to reschedule in the event that the meeting can be rescheduled as a face-to-face meeting.

At step 230, information pertaining to each attendee of the meeting is monitored and collected based on the one or more parameters or preferences set up in step 215. For example, the scheduling tool (e.g., scheduling tool 50 as discussed with respect to FIGS. 1 and 2) begins monitoring and collecting attendee information based on the one or more parameters or preferences provided and saved in the preference table (e.g., the preference table 135 as discussed with respect to FIG. 2). In embodiments, the collected attendee information may be saved in the database or hash table (e.g., database or hash table 110 described with respect to FIG. 2) and associated with each attendee and their corresponding computing device.

In accordance with aspects of the present invention, if the host selected in step 215 a minimum number of possible co-located attendees, the scheduling tool will track and save the attendees' locations using various techniques such as their IP address (e.g., obtained from electronic directory 125 and saved in database 110 as discussed with respect to FIG. 2), GPS (e.g., obtained from GPS unit 90, 95, and 100 and saved in database 110 as discussed with respect to FIG. 2), company ID card databases (e.g., obtained from electronic directory 125 and saved in database 110 as discussed with respect to FIG. 2), etc. If the host selected in step 215 authorization to review attendees' travel schedules, the scheduling tool 50 will capture the attendees' travel plans using various techniques such as a vacation planner and/or leave database (e.g., leave database 140 as discussed with respect to FIG. 2), online travel reservations, etc. to identify whether the attendees are travelling to a same geographic location.

In additional embodiments, if the host selected in step 215 a minimum number of possible co-located attendees and/or authorization to review attendees' travel schedules, the scheduling tool 50 may also be configured to search various applications (e.g., one or more applications 75, 80, and 85 as discussed with respect to FIG. 2) within the attendees computing device to collect information related to a present location of the attendee, future travel plans or presence information pertaining to the attendee, attendance information, etc. For example, the scheduling tool 50 may be configured to search the instant messaging application of each attendee, the browsing history from a browser of each attendee, text messages of each attendee, emails from an email application of each attendee, etc. to collect a present location of the attendee, future travel plans or presence information pertaining to the attendee, attendance information, etc. As should be understood, access to the various applications on the attendees computing device via the scheduling tool may be authorized by the attendee in a registration process and saved within the database or hash table as part of the processes described in step 205.

FIG. 4 is a flow diagram illustrating a process 300 for determining whether one or more attendees of a meeting are co-located and rescheduling a face-to-face meeting based on the determination. At step 305, a determination is made as to whether at least a defined minimum number of attendees are or will be co-located at a comparable time. For example, the scheduling tool (e.g., scheduling tool 50 as described with respect to FIGS. 1 and 2) will analyze all of the information monitored and collected in step 230 described with respect to FIG. 3, and determine whether physical locations of a defined minimum number of attendees is or will be similar (e.g., within a pre-set radius of miles, same country or state, same city or town, same structure, etc.) at a comparable time (e.g., within a pre-set time of one day). If there are, for example, five attendees, the defined minimum number of attendees is set at three, and four of the five attendees are scheduled to be in a same city on a same day, then the scheduling tool may be configured to make the determination that the defined minimum number of attendees will be co-located at a comparable time.

At step 310, when the defined minimum number of attendees will not be co-located at a comparable time, a determination is made as to whether at least a defined minimum number of attendees satisfy a grouping of attendees at a comparable time to reschedule a meeting as a face-to-face meeting on a group level. For example, the scheduling tool (e.g., scheduling tool 50 as described with respect to FIGS. 1 and 2) will analyze all of the information monitored and collected in step 230 described with respect to FIG. 3, and determine whether physical locations of a defined minimum number of attendees that satisfy a grouping of attendees is or will be similar (e.g., within a pre-set radius of miles, same country or state, same city or town, same structure, etc.) at a comparable time (e.g., within a pre-set time of one day). If there are, for example, ten attendees, the defined minimum number of attendees to satisfy a grouping is set at three, and four of the ten attendees are scheduled to be in a same city on a same day, then the scheduling tool may be configured to make the determination that the defined minimum number of attendees will be co-located at a comparable time such that the four attendees could possible meet face-to-face as a group to attend the meeting. The remaining six attendees can attend the meeting via telephone or web conference.

At step 315, when the defined minimum number of attendees does not satisfy a co-located grouping of attendees, the process returns to step 230 as described with respect to FIG. 3 and additional information pertaining to each attendee of the meeting is continuously monitored and collected.

At step 320, when the defined minimum number of attendees will be co-located at a comparable time or the defined minimum number of attendees satisfies a co-located grouping of attendees at a comparable time, a determination is made as to whether the comparable time is within an advancement or postponement window for rescheduling the meeting. The advancement window is bounded by a minimum number of days prior to the scheduled meeting that must be available to reschedule the meeting and the set meeting time. The postponement window is bounded by a maximum number of days in the future beyond the set meeting time that is available and cannot be surpassed to reschedule the meeting and the set meeting time. For example the scheduling tool (e.g., scheduling tool 50 as described with respect to FIGS. 1 and 2) will compare the comparable time to the advancement window and the postponement window, which are based on the one or more parameters and preferences set in step 215 as discussed with respect to FIG. 3, and determine whether the comparable time is within the advancement window or the postponement window. If, for example, the comparable time is one day after the time for the scheduled meeting, the defined minimum number of days is two, and the maximum number of days is four, then the scheduling tool may be configured to make the determination that the comparable time is within the postponement window, and thus the meeting can be rescheduled. On the other hand, if, for example, the comparable time is two days prior to the time of the scheduled meeting, the defined minimum number of days is two, and the maximum number of days is four, then the scheduling tool may be configured to make the determination that the comparable time is within the advancement window, and thus the meeting can be rescheduled.

At step 325, when the comparable time is not within the advancement or postponement window, the process returns to step 230 as described with respect to FIG. 3 and additional information pertaining to each attendee of the meeting is continuously monitored and collected.

At step 330, when the comparable time is within the advancement or postponement window, a notification is sent to the host that there is a possibility for the meeting to be rescheduled as face-to-face meeting. For example, the scheduling tool (e.g., scheduling tool 50 as described with respect to FIGS. 1 and 2) may be configured to generate a pop up message on the computing device of the host that notifies the host that there is a possibility for the meeting to be rescheduled as face-to-face meeting.

At step 335, the host makes a decision as to whether they may be interested in rescheduling the meeting as a face-to-face meeting. For example, the host may select to accept or decline the notification for the possibility of rescheduling the meeting as a face-to-face-meeting. At step 340, when the host makes a decision that they are not interested in rescheduling the meeting, the process ends for the present meeting. At step 345, when the host makes a decision that they are interested in rescheduling the meeting as a face-to-face meeting, resource(s) and availability information are gathered for the meeting and presented to the host. For example the scheduling tool (e.g., scheduling tool 50 as described with respect to FIGS. 1 and 2) will gather potential resource information for conducting the face-to-face meeting, availability slots for attendees, a number of attendees that can attend the meeting face-to-face, a number of attendees that will attend via telephone or web conference, the names of each of the attendees that will attend the meeting face-to-face, the names of each of the attendees that will attend via telephone or web conference, etc. The gathered information may then be presented to the host, for example, in a report format such that the host can make an informed decision on whether to proceed with rescheduling the meeting as a face-to-face meeting.

In embodiments, the information regarding potential resource(s) to conduct the face-to-face meeting may be provided optionally based on whether the host has authorized the scheduling tool to find resources for holding the face-to-face meeting. For example, when the one or more parameters or preferences are selected in step 215 as discussed with respect to FIG. 2 for finding resources for holding a face-to-face meeting, the scheduling tool may be further configured to search various applications such as a company directory or the Internet to locate, for example, an office space or a coffee shop, in which to conduct the face-to-face meeting. In embodiments, the resources may also include a place to conduct the meeting, and anything requested for conducting the meeting such as audio visual equipment, a translator, refreshments, etc.

In embodiments, the availability slots of the attendees includes a list of potential times for conducting the meeting in a face-to-face manner that are within the postponement or advancement window, and the attendees that are available for each time slot. For example, the scheduling tool may be further configured to use the gathered information for each attendee to propose one or more times for conducting the meeting as a face-to-face meeting while keeping within the predefined one or more parameters or preferences.

At step 350, the host makes a decision as to whether they are going to reschedule the meeting as a face-to-face meeting. For example, the host may select to accept or decline a proposed time for rescheduling the meeting as a face-to-face-meeting. The decision by the host may also include a decision of resources available for the proposed meeting time. At step 355, when the host makes a decision that they are not going to proceed with rescheduling the meeting, the process ends for the present meeting. At step 360, when the host makes a decision that they are interested in rescheduling the meeting as a face-to-face meeting, a reschedule meeting request is sent to the attendees, time for the meeting is blocked off on the electronic calendar of the host, and acceptances of the reschedule meeting request by the attendees are tracked. For example, the scheduling tool (e.g., scheduling tool 50 as described with respect to FIGS. 1 and 2) may be configured to send out a reschedule meeting invite to all attendees of the previously scheduled meeting, block off time for rescheduled meeting on the host's electronic calendar, and track acceptances of the reschedule meeting request from the attendees.

At step 365, when the number of acceptances by the attendees is less than the number of rejections by the attendees, the scheduling tool will allow the host to proceed with the previously schedule meeting and unblock the rescheduled meeting time from the host's electronic calendar. At step 370, when the number of acceptances by the attendees is greater than the number of rejections by the attendees, the scheduling tool will proceed with update all attendees electronic calendars with the rescheduled meeting time including resources and location selected by the host for the meeting. For example, the scheduling tool (e.g., scheduling tool 50 as described with respect to FIGS. 1 and 2) may be configured to block off time for rescheduled meeting on the attendees' electronic calendars (e.g., applications 75, 80, and 85 as discussed with respect to FIG. 2) and include resources for the meeting.

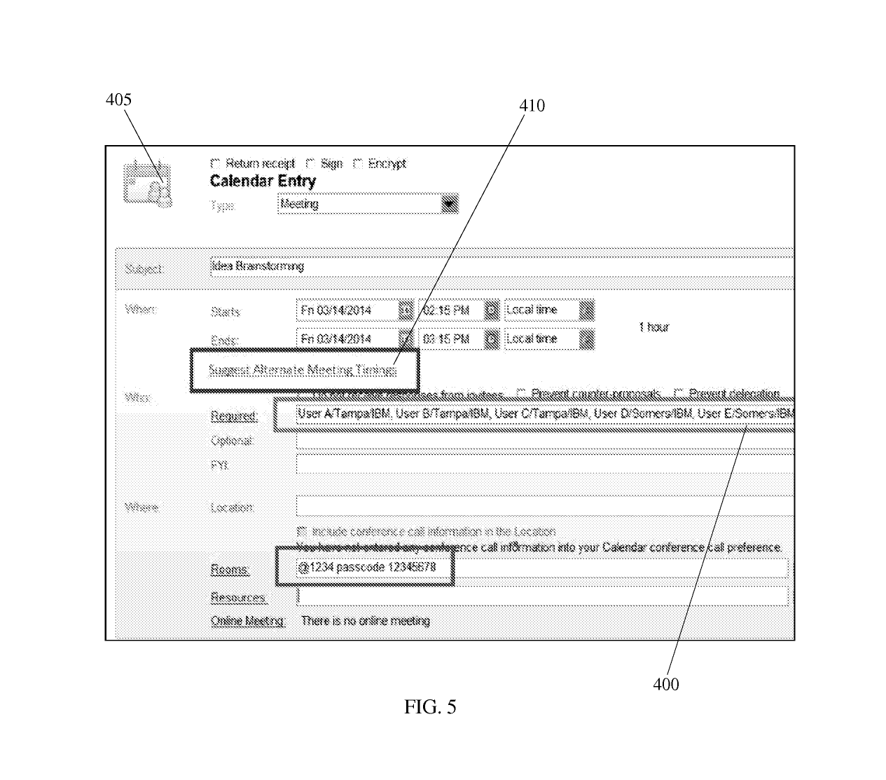

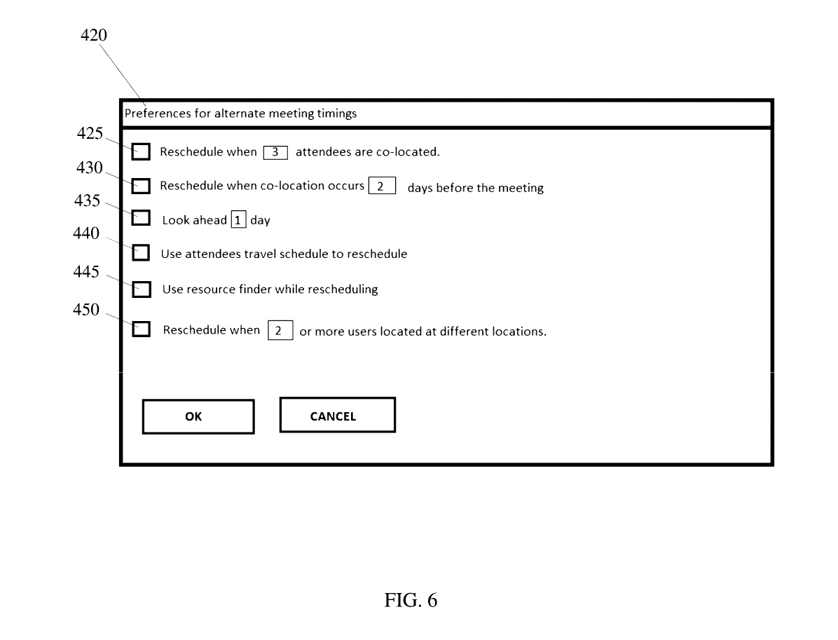

FIGS. 5 and 6 show an exemplary use (user interface) of the present invention. As should be understood the exemplary use is merely provided for illustrative purposes and should not be considered limiting on the present invention. More specifically, as shown in FIG. 5, consider an example where there are six users 400 (i.e., potential invitees): User A, User B, User C, User D, User E and User F. While scheduling a meeting using a scheduling or calendaring application 405, the host may be presented with an option to select use of a scheduling tool via a graphical user interface button or universal resource link 410 to obtain additional functionality for rescheduling the meeting if the meeting can occur face-to-face rather than remotely (e.g., via a telephone or web conference).

As shown in FIG. 6, once the host elects to utilize functionality of the scheduling tool, the scheduling tool is configured to communicate with the scheduling or calendaring application to obtain one or more preferences or parameters 420 (e.g., using parameters and preferences program 130, which maintains a parameters and preferences table 135 as described with respect to FIG. 2) from the user for the meeting that define conditions upon which the scheduling tool may reschedule the meeting if the meeting can occur face-to-face. The host can use all of the parameters and preferences or any combination of them based on their needs and the nature of attendees (e.g., their locations, travel schedule, etc.). The first option 425 “Reschedule when 3 attendees are co-located” will provide a host with an option to reschedule when 3 or more attendees are co-located. For example: If User A, User C and User D are present at location X OR User A, User E and User F are present at location Y then a reschedule may occur. The number of attendees (i.e., 3 in this case) is configurable and the host can provide any value as per their convenience.

The second option 430 “Reschedule when co-location occurs 2 days before the meeting” can be used in conjunction with option 1. It will first check for the co-location and if satisfied then check the number of days configured by the host. If both the conditions are satisfied, the scheduling tool will provide a notification of the possibility for a reschedule to a face-to-face meeting. The number of days (i.e., 2 in this case) is configurable and the host can provide any value as per their convenience. The third option 435 “Look ahead feature” will allow the host to look for future dates to postpone the meeting if they are planning to co-locate on a later date rather than the scheduled meeting date. For example: If the host has scheduled a meeting on Wednesday (which will be a telephonic meeting) and if they could co-locate on Thursday or Friday then the scheduling tool will provide a notification of the possibility for a reschedule to a face-to-face meeting. The number of days to look ahead (i.e., 1 in this case) is configurable and the host can provide any value as per their convenience.

The fourth option 440 “Rescheduling Meetings based on travel schedule” can be used to allow a user to reschedule meetings by tracking attendees' travel schedules. For example: If user A lives in city X but is traveling to City Z and user B lives in city Y but is also traveling to city Z, as long as both parties are near to each other somewhere in City Z, then the scheduling tool will provide a notification of the possibility for a reschedule to a face-to-face meeting. The travel schedule can be tracked using applications used to plan and book travel arrangements and maintain travel schedules.

The fifth option 445 “Resource finding based on location of attendees” can be used to find resources such as meeting rooms if a host decides to reschedule a meeting. Depending upon location of attendees, the scheduling tool could find an available conference room inside an office building, outside office building, it could find a restaurant, cafe, or another public place that is open. The sixth option 450, “Rescheduling Meetings based on location of different group of attendees” can be used to reschedule if different groups of attendees planned to co-locate at different locations. For example: If calendaring service finds User A and User B near each other and User C and User D near each other. Calendaring service could find a time where group 1 (User A and User B) can meet in person and group 2 (User C and User D) can meet in person and schedule a conference call between the two groups.

In embodiments, the invention provides a method that performs the process of the invention on a subscription, advertising, and/or fee basis. That is, a service provider, such as a Solution Integrator, could offer to provide the data collection and meeting reschedule functionality on a network. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for collecting data and rescheduling meetings on a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented in a computer infrastructure having computer executable code tangibly embodied on a computer readable storage medium having programming instructions operable to:
collect location information from each attendee of a scheduled meeting;
determine whether a minimum number of the attendees of the scheduled meeting will be co-located at a comparable time;
when the minimum number of the attendees will be co-located at the comparable time, determine whether the comparable time is within an advancement or postponement window of time;
when the comparable time is within the advancement or postponement window of time, send a notification to a host of the scheduled meeting that there is an opportunity to reschedule the scheduled meeting as a face-to-face meeting at the comparable time;
receive a request to reschedule the scheduled meeting as the face-to-face meeting; and
reschedule the scheduled meeting as the face-to-face meeting.

2. The method of claim 1, wherein the location information includes at least one of global positioning coordinate system coordinates for a mobile device of each attendee of the scheduled meeting, upcoming travel itineraries stored in a company travel database of each attendee of the scheduled meeting, and IP addresses for a computing device of each attendee of the scheduled meeting.

3. The method of claim 1, wherein the advancement window is bounded by a minimum number of days prior to a time of the scheduled meeting that must be available to reschedule the scheduled meeting.

4. The method of claim 3, wherein the postponement window is bounded by a maximum number of days in the future beyond the time of the scheduled meeting that is available and cannot be surpassed to reschedule the scheduled meeting.

5. The method of claim 1, wherein the programming instructions are further operable to:
when the minimum number of the attendees will not be co-located at the comparable time, determine whether at least a defined minimum number of the attendees satisfy a grouping of attendees at a comparable time to reschedule the scheduled meeting as the face-to-face meeting on a group level;
when at least the defined minimum number of the attendees satisfy the grouping of attendees at the comparable time, determine whether the comparable time is within the advancement or postponement window of time;
when the comparable time is within the advancement or postponement window of time, send the notification to the host of the scheduled meeting that there is the opportunity to reschedule the scheduled meeting as the face-to-face meeting at the comparable time;
receive the request to reschedule the scheduled meeting as the face-to-face meeting; and
reschedule the scheduled meeting as the face-to-face meeting.

6. The method of claim 1, wherein the programming instructions are further operable to:
receive a notice of interest in rescheduling the scheduled meeting as the face-to-face meeting;
obtain attendee information and resource information for the face-to-face meeting;
send the attendee information and the resource information to the host;
receive the request to reschedule the scheduled meeting as the face-to-face meeting; and
reschedule the scheduled meeting as the face-to-face meeting.

7. The method of claim 6, wherein the resource information includes an office space or a public space in which to conduct the face-to-face meeting.

8. The method of claim 1, wherein a service provider at least one of creates, maintains, deploys and supports the computer infrastructure.

9. A computer program product for rescheduling a scheduled meeting as a face-to-face meeting on a computing device, the computer program product comprising a computer readable storage medium having program instructions embodied therewith, wherein the computer readable storage medium is not a transitory signal per se, and the program instructions are readable by a computing device to cause the computing device to perform a method comprising:
obtaining information pertaining to the scheduled meeting, the information including a list of attendees of the meeting and a mobile device for each attendee;
collecting location information from the mobile device of each attendee of the scheduled meeting;
determining whether a minimum number of the attendees of the scheduled meeting will be co-located at a comparable time based on the location information;
when the minimum number of the attendees will be co-located at the comparable time, determining whether the comparable time is within an advancement or postponement window of time;
when the comparable time is within the advancement or postponement window of time, sending a notification to a host of the scheduled meeting that there is an opportunity to reschedule the scheduled meeting as the face-to-face meeting at the comparable time;
receiving a request to reschedule the scheduled meeting as the face-to-face meeting; and
rescheduling the scheduled meeting as the face-to-face meeting.

10. The computer program product of claim 9, wherein the advancement window is bounded by a minimum number of days prior to a time of the scheduled meeting that must be available to reschedule the scheduled meeting.

11. The computer program product of claim 10, wherein the postponement window is bounded by a maximum number of days in the future beyond the time of the scheduled meeting that is available and cannot be surpassed to reschedule the scheduled meeting.

12. The computer program product of claim 11, wherein the method further comprises:
when the minimum number of the attendees will not be co-located at the comparable time, determining whether at least a defined minimum number of the attendees satisfy a grouping of attendees at a comparable time based on the location information;
when at least the defined minimum number of the attendees satisfy the grouping of attendees at the comparable time, determining whether the comparable time is within the advancement or postponement window of time;
when the comparable time is within the advancement or postponement window of time, sending the notification to the host of the scheduled meeting that there is the opportunity to reschedule the scheduled meeting as the face-to-face meeting at the comparable time;
receiving the request to reschedule the scheduled meeting as the face-to-face meeting; and
rescheduling the scheduled meeting as the face-to-face meeting.

13. The computer program product of claim 9, wherein the method further comprises:
receiving a notice of interest in rescheduling the scheduled meeting as the face-to-face meeting;
obtaining attendee information and resource information for the face-to-face meeting;
sending the attendee information and the resource information to the host;
receiving the request to reschedule the scheduled meeting as the face-to-face meeting; and
rescheduling the scheduled meeting as the face-to-face meeting.

14. The computer program product of claim 13, wherein the resource information includes an office space or a public space in which to conduct the face-to-face meeting.

15. A system comprising:
a CPU, a computer readable memory and a computer readable storage medium;
program instructions to receive user preferences for a layout or format of content displayed on a computing device;
program instructions to obtain information pertaining to a scheduled telephone or web conference meeting, the information including a list of attendees of the meeting and a mobile device for each attendee;
program instructions to collect location information from the mobile device of each attendee of the scheduled telephone or web conference meeting;
program instructions to collect travel itinerary information stored in a company travel database for each attendee of the scheduled telephone or web conference meeting;
program instructions to determine whether a minimum number of the attendees of the scheduled telephone or web conference meeting will be co-located at a comparable time based on the location information and travel itinerary information;
program instructions to when the minimum number of the attendees will be co-located at the comparable time, determine whether the comparable time is within an advancement or postponement window of time;
program instructions to when the comparable time is within the advancement or postponement window of time, send a notification to a host of the scheduled telephone or web conference meeting that there is an opportunity to reschedule the scheduled telephone or web conference meeting as the face-to-face meeting at the comparable time;
program instructions to receive a request to reschedule the scheduled telephone or web conference meeting as the face-to-face meeting; and
program instructions to reschedule the scheduled telephone or web conference meeting as the face-to-face meeting,
wherein the program instructions are stored on the computer readable storage medium for execution by the CPU via the computer readable memory.

16. The system of claim 15, wherein the advancement window is bounded by a minimum number of days prior to a time of the scheduled telephone or web conference meeting that must be available to reschedule the scheduled meeting.

17. The system of claim 16, wherein the postponement window is bounded by a maximum number of days in the future beyond the time of the scheduled telephone or web conference meeting that is available and cannot be surpassed to reschedule the scheduled meeting.

18. The system of claim 17, further comprising:
program instructions to determine whether at least a defined minimum number of the attendees satisfy a grouping of attendees at a comparable time based on the location information when the minimum number of the attendees will not be co-located at the comparable time;
program instructions to determine whether the comparable time is within the advancement or postponement window of time when at least the defined minimum number of the attendees satisfy the grouping of attendees at the comparable time;
program instructions to send the notification to the host of the scheduled telephone or web conference meeting that there is the opportunity to reschedule the scheduled telephone or web conference meeting as the face-to-face meeting at the comparable time when the comparable time is within the advancement or postponement window of time;
program instructions to receive the request to reschedule the scheduled telephone or web conference meeting as the face-to-face meeting; and
program instructions to reschedule the scheduled telephone or web conference meeting as the face-to-face meeting.

19. The system of claim 18, further comprising:
program instructions to receive a notice of interest in rescheduling the scheduled telephone or web conference meeting as the face-to-face meeting;
program instructions to obtain attendee information and resource information for the face-to-face meeting;
program instructions to send the attendee information and the resource information to the host;
program instructions to receive the request to reschedule the scheduled telephone or web conference meeting as the face-to-face meeting; and
program instructions to reschedule the scheduled telephone or web conference meeting as the face-to-face meeting.

20. The system of claim 19, wherein the resource information includes an office space or a public space in which to conduct the face-to-face meeting.
